(19) United States
(12) Patent Application Publication
(10) Pub. No.: US 2010/0086745 A1
(43) Pub. Date: Apr. 8, 2010

(54) COMOPOSITE SPUNBONDED NONWOVEN

(75) Inventors: HIDEMI ITO, SHIGA (JP); TAIJU TERAKAWA, SHIGA (JP)

Correspondence Address: J C PATENTS, 4 VENTURE, SUITE 250, IRVINE, CA, 92618, US

(73) Assignees: CHISSO CORPORATION, OSAKA (JP); CHISSO POLYPRO FIBER CO., LTD., TOKYO (JP)

(21) Appl. No.: 12/575,679

(22) Filed: Oct. 8, 2009

(30) Foreign Application Priority Data
Oct. 8, 2008 (JP) 2008-262187
Aug. 4, 2009 (JP) 2009-181774

(51) Int. Cl. B32B 3/28

(52) U.S. Cl. 428/176

(57) ABSTRACT

A composite spunbond nonwoven and a laminate using the same are provided. The composite spunbond nonwoven is formed of a composite fiber including a low melting point component and a high melting point component. The composite fiber is partially thermal compression bonded to each other, and thermal compression bonded portions have fine folded structures formed by repeating convex portions and concave portions in a CD (cross direction in nonwoven manufacturing). An average of distances between adjacent convex portions of the folded structures is in a range of 100 μm-400 μm. The composite spunbond nonwoven exhibits an elongation property by unfolding the fine folded structures. When the composite spunbond nonwoven is elongated by 5%, a CD strength is less than or equal to 0.1 N/5 cm width, and a MD/CD strength ratio is greater than or equal to 200. MD is longitudinal direction in nonwoven manufacturing.

### CROSS-REFERENCE TO RELATED APPLICATION

This application claims the priority benefit of Japan application serial no. 2008-262187, filed Oct. 8, 2008 and serial no. 2009-181774, filed Aug. 4, 2009. The entirety of the above-mentioned patent application is hereby incorporated by reference herein and made a part of specification.

### BACKGROUND OF THE INVENTION

1. Field of the Invention

The present invention generally relates to a nonwoven having a low stress elongation in one direction and a laminate using the same, in particular, to a nonwoven having a low stress elongation as a single layer or the nonwoven in which a sheet stretchable material is formed by integrating multiple layers, so as to be advantageously used to form a sheet material easy to process and having excellent elongation property or stretchability, air permeability, and softness as well as good feel and high damage resistance (or large breaking or tear strength), and most suitable to be used as a material for manufactured articles such as clothes in direct contact with skin or sanitary products such as dust masks and disposable diapers.

2. Description of Related Art

A common spunbond nonwoven or thermal bond nonwoven is low costing and mostly used as a general purpose nonwoven convenient to use, but it almost has no low stress elongation defined in the present invention. Besides, one general purpose nonwoven exhibiting a low stress elongation is spunlace nonwoven, but the low stress elongation thereof is incomparable to that defined in the present invention, and the spunlace nonwoven is relatively expensive in terms of the manufacturing cost. In addition, nonwovens having a low stress elongation include a tow-opening nonwoven similar to parallel fiber bundles and a foam net obtained through a melt extrusion method, but these nonwovens have very small cross direction (CD, cross direction in nonwoven manufacturing) strength and are not applicable to the objective of the present invention. The following patent documents have disclosed methods for solving this problem.

Japanese Patent Publication No. H07-54256 has disclosed a laminate in which folds are formed on one surface based on a shrinkage difference between two layers; however, the folds cannot be unfolded even if a tension is applied.

Japanese Patent Publication No. 2004-521775 has disclosed a nonwoven web having an elongated neck, but a surface of the nonwoven web is “flat” in the disclosure. The patent has further disclosed that folds are formed on a surface of a film laminated on the nonwoven web with CD shrinkage (“width shrinkage”) of the nonwoven web.

In Japanese Patent Publication No. 2004-76178, a gear roll is used to assign a concave-convex shape to a nonwoven; however, the concave-convex structure is formed on an entire surface of the nonwoven and has a height of 2 mm-30 mm and a wavelength of 2 mm-50 mm, and thus is a large concave-convex structure.

### SUMMARY OF THE INVENTION

In the above described methods, in the case that a nonwoven is formed of multiple layers, softness or sufficient elongation or stretchability cannot be obtained, and thus a nonwoven most suitable to be used as a raw material for manufactured articles such as clothes in direct contact with skin or sanitary products cannot be provided. Accordingly, the present invention is directed to a nonwoven having a low stress elongation that is inexpensive and convenient to use.

In the present invention, a composite spunbond raw nonwoven formed of composite fibers including a low melting point component and a high melting point component, upon part of which a moderate thermal compression bonding is performed is needed. Then, fine folded structures formed by repeating convex portions and concave portions in a cross direction (CD, cross direction in nonwoven manufacturing) are formed at thermal compression bonded portions by extending the raw nonwoven in a longitudinal direction in nonwoven manufacturing (machine direction, MD) under predetermined conditions, so as to form a composite spunbond nonwoven of the present invention that exhibits an elongation property by unfolding the fine folded structures.

The present invention is constructed as follows.

A composite spunbond nonwoven formed of composite fiber including a low melting point component and a high melting point component, in which the composite fiber is partially thermal compression bonded to each other, thermal compression bonded portions have fine folded structures formed by repeating convex portions and concave portions in a CD (cross direction in nonwoven manufacturing), an average of distances between adjacent convex portions of the folded structures is in a range of 100 μm-400 μm, the composite spunbond nonwoven exhibits an elongation property by unfolding the fine folded structures, and when the composite spunbond nonwoven is elongated by 5%, a CD strength is less than or equal to 0.1 N/5 cm width, and an MD/CD strength ratio (“longitudinal direction in nonwoven manufacturing/cross direction in nonwoven manufacturing” strength ratio) is greater than or equal to 200.

According to an embodiment of the present invention, the CD strength is less than or equal to 5 N/5 cm width when the composite spunbond nonwoven is elongated by 50%.

According to an embodiment of the present invention, a raw nonwoven before the folded structures are formed satisfies the following provisions of (A)-(C):

(A) an overall area rate of the thermal compression bonded portions is 7%-60% of the nonwoven;

(B) an occupancy of the thermal compression bonded portions continuously dotted in the MD relative to an overall CD width is greater than or equal to 50%; and

(C) an MD dry heat shrinkage rate is 3.5%-23%.

According to an embodiment of the present invention, the raw nonwoven before the folded structures are formed satisfies the following provisions of (A)-(C):

(A) an overall area rate of the thermal compression bonded portions is 7%-60% of the nonwoven;

(B) an occupancy of the thermal compression bonded portions continuously dotted in the MD relative to an overall CD width is greater than or equal to 50%; and

(C) an MD dry heat shrinkage rate is 3.5%-23%,

and the raw nonwoven is uniaxially extended in the MD.

According to an embodiment of the present invention, a ratio of a CD width after the extension to a CD width before the extension is 0.1-0.7.

A laminate, which is formed by integrally forming other fiber layers or films with the composite spunbond nonwoven.

An article, which is obtained by using the composite spunbond nonwoven or the laminate.

### EFFECT OF THE INVENTION

The present invention achieves the following effects. A nonwoven which is an inexpensive sheet material easy to process and having excellent elongation property, air permeability, and softness as well as a good feel, and most suitable to be used as a material for manufactured articles such as clothes in direct contact with skin or sanitary products such as dust masks and disposable diapers is provided. In addition, a laminate using the nonwoven is provided. Furthermore, an article formed by using the nonwoven or the laminate is provided.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B are schematic view of fine folded structures of thermal compression bonded portions of the present invention.

FIGS. 2A and 2B are schematic view of an illustration of a pattern (grid arrangement) of thermal compression bonded portions of a raw nonwoven used in the present invention and a CD occupancy thereof.

FIGS. 3A to 3C are a schematic view of an illustration of a pattern (grid arrangement rotated by α°) of thermal compression bonded portions of the raw nonwoven used in the present invention and a CD occupancy thereof.

FIGS. 4A and 4B are a schematic view of an illustration of a pattern (staggered arrangement) of thermal compression bonded portions of the raw nonwoven used in the present invention and a CD occupancy thereof.

FIGS. 5A and 5B are a schematic view of an illustration of a pattern (irregular shape) of thermal compression bonded portions of the raw nonwoven used in the present invention and a CD occupancy thereof.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

In order to manufacture a nonwoven having an excellent low stress elongation that is applicable to the objectives of the present invention, preferably, a composite spunbond nonwoven in which the raw nonwoven before folded structures are formed at thermal compression bonded portions retains an appropriate MD dry heat shrinkage rate and a fiber structure of the high melting point component is unmeltingly maintained in the thermal compression bonded portions. In this case, if the high melting point component in the thermal compression bonded portions maintains a fiber shape, the integral formation of a low melting point component throughout the thermal compression bonded portions by hot melting is not influenced. By heating and extending (in terms of the extension, a composite spunbond nonwoven is preferably used as the raw nonwoven) the raw nonwoven in an MD, composite filament in an random arrangement existing in areas other than the thermal compression bonded portions moves along the MD as orientating, and under a reaction thereof, the nonwoven applies a stress along an inner side of a CD to achieve width shrinkage in the CD. At this time, although the stress intending to elongate the thermal compression bonded portions is applied to the thermal compression bonded portions, the MD orientation of the filament in the areas other than the thermal compression bonded portions is predominant, such that the thermal compression bonded portions are not elongated by the desired extension ratio (drawing ratio) and are not destroyed. Then, although the stress is applied similarly along the inner side of the CD (as the CD shrinkage) in the thermal compression bonded portions, the residual deformation stress due to no such stretching in the MD produces a stress relief phenomenon in which folded structures are exhibited in the CD. Furthermore, since the residual (unmelted) high melting point component with heat shrinkability exists in the thermal compression bonded portions maintaining the fiber structure, fine folded structures can be easily formed through a combinational effect with the function of shrinkage.

In comparison to this, in the case that the raw nonwoven is spunbond nonwoven formed of single-component fibers, in order to maintain sufficient strength, fibers of thermal compression bonded portions are required to be almost completely melted and solidified. Even if this nonwoven is extended, the areas other than the thermal compression bonded portions function similarly as the above described, but the thermal compression bonded portions are harder than those in the present invention, and thus sufficient folded structures cannot be obtained. In addition, even the raw nonwoven is compositely spunbonded, it goes the same if the state in which a high melting point component of the thermal compression bonded portions is melted and solidified.

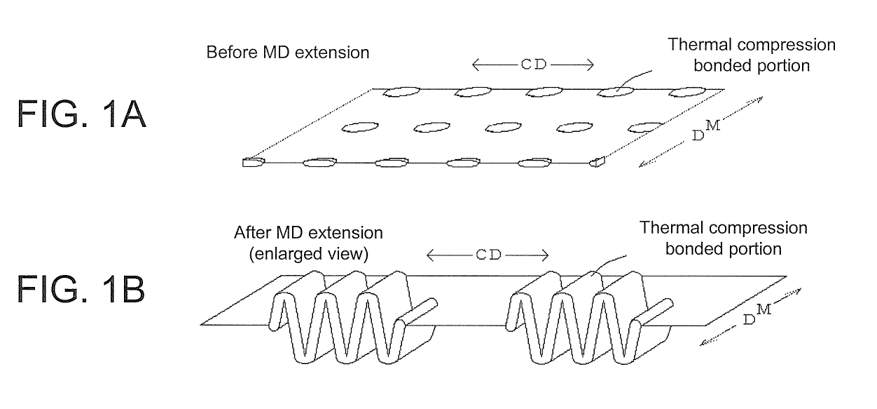

The fine folded structures of the thermal compression bonded portions in the present invention are as shown in FIG. 1. Regarding the fine folded structures of the thermal compression bonded portions, adjacent folded structures may be in contact with or spaced apart from each other. Distances between adjacent convex portions or concave portions of adjacent folded structures depend on physical properties or a structure of fibers and extension conditions of the raw nonwoven, and especially depend to a large extent on a state of the thermal compression bonded portions of the nonwoven. The objective distances between adjacent convex portions of the folded structures of the thermal compression bonded portions of the present invention are in the range of 100 μm-400 μm, and preferably 100 μm-300 μm. When the distances between adjacent convex portions are 100 μm-400 μm, a sufficient degree of elongation can be obtained. Besides, even if the raw nonwoven having a low weight per square meter is not used beyond the demand, the sufficient degree of elongation can also be obtained and thermal extension is easily performed uniformly, so as to maintain a homogeneous low stress elongation.

The nonwoven of the present invention has an elongation property under an extremely low stress in the CD. As for its index, when the nonwoven is elongated by 5%, a CD strength is less than or equal to 0.1 N/5 cm width, preferably less than or equal to 0.100 N/5 cm width, more preferably less than or equal to 0.050 N/5 cm width, and particularly preferably less than or equal to 0.010 N/5 cm width. Moreover, when the nonwoven is elongated by 5%, an MD/CD strength ratio is greater than or equal to 200, preferably greater than or equal to 300, and more preferably greater than or equal to 400. A limitation of an upper limit of the MD/CD strength ratio is insignificant since the CD strength is sometimes less than or equal to a measurement limit (0.001 N/5 cm) of a tensile testing machine. However, considering that a maximum of an MD strength is about 100 N/5 cm in the Examples of the present invention, the upper limit of the MD/CD strength ratio is about 100000; considering that the MD strength may further rise (it is assumed that the upper limit is about 200 N/5 cm), the upper limit of the MD/CD strength ratio may be estimated to be about 200000. In order to make the effect of the present invention more definite, when the nonwoven is elongated by 50%, the CD strength is less than or equal to 5 N/5 cm width, preferably less than or equal to 5.000 N/5 cm width, more preferably less than or equal to 3.000 N/5 cm width, and particularly preferably less than or equal to 1.000 N/5 cm width, and a lower limit thereof is the measurement limit (0.001 N/5 cm) of the tensile testing machine.

A combination of resin components of the composite spunbond nonwoven is illustrated. For the low melting point component and the high melting point component, for example, a combination of common thermoplastic resins, i.e., polyethylene (PE), polypropylene (PP), polyester (for example, polyethylene terephthalate (PET)), and nylon, may be used. For PE, high density PE, low density PE, and linear low density PE may be used. A form of the composite fibers may be a core-sheath type composite fibers having a low melting point component disposed at a sheath side and a high melting point component disposed at a core side, and a composite form in which part of the high melting point component is exposed out of the surface of the fibers with a surface area less than or equal to 50% may also be used. In the case of a single component, in order to have an MD strength endurable to extension, conditions of the thermal compression bonding processing must be severe, and thus the fiber structure cannot remain in the thermal compression bonded portions to the extent of the property of heat shrinkability of the residual fibers, so that the nonwoven in the present invention is difficult to obtain. The same is true of core-sheath type composite fibers having a high melting point component disposed at the sheath side and a low melting point component disposed at the core side. Specific combinations of the thermoplastic resins of the composite spunbond nonwoven in the present invention are preferably PE/PP, PE/nylon, PE/PET, PP/nylon, PP/PET, or nylon/PET for low melting point component/high melting point component. To ensure that the fiber structure remains in the thermal compression bonded portions to the extent of the property of heat shrinkability of the residual fibers, the combination of PE/PET is particularly preferred since the larger melting point difference is, the fewer restrictions on the processing conditions will be.

The present invention is further characterized in that: an overall area ratio of the thermal compression bonded portions to the raw nonwoven before folded structures are formed is preferably 7%-60%, and particularly preferably 10%-50%. By limiting the overall area ratio in this range, an area of the thermal compression bonded portions that should exhibit the fine folded structures can be sufficiently ensured without damaging the softness and air permeability of the nonwoven.

In addition, for the raw nonwoven used in the present invention, it is preferable that an occupancy of the thermal compression bonded portions continuously dotted in the MD relative to an overall CD width is greater than or equal to 50%, and more preferably greater than or equal to 70%. The occupancy of the thermal compression bonded portions continuously dotted in the MD relative to the overall CD width (“CD occupancy”) is illustrated below.

In the present invention, the CD occupancy changes with a pattern of the thermal compression bonded portions, and is related to the effect of the present invention. Thus, the pattern of the thermal compression bonded portions is illustrated first.

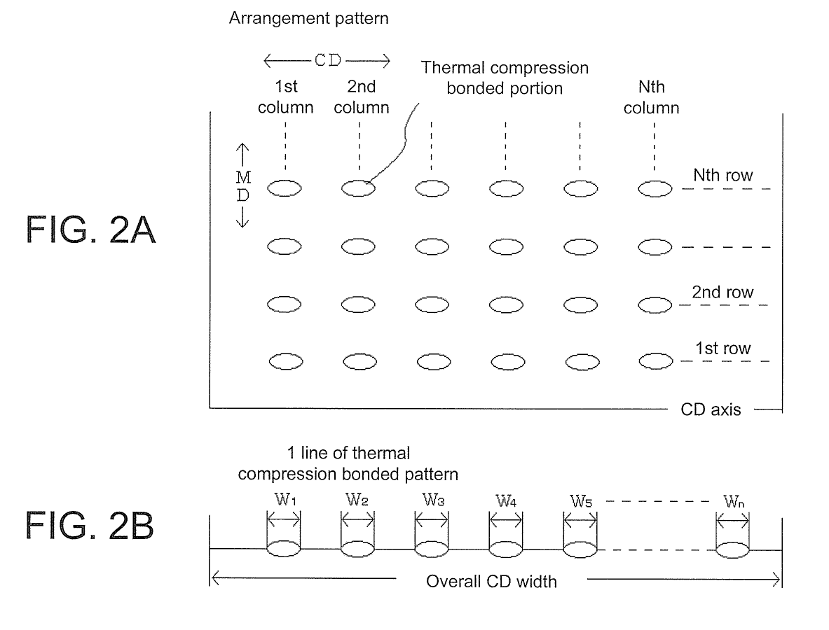

A pattern of thermal compression bonded portions in FIG. 2(A) is a grid arrangement formed through orthogonal intersection of ranks of thermal compression bonded portions in the CD (CD rows) with ranks of thermal compression bonded portions in the MD (MD columns). The CD rows and the MD columns are respectively arranged at equal intervals. The interval between the CD rows may be the same as or different from that between the MD columns. The CD occupancy may be calculated by projecting all the thermal compression bonded portions on a CD axis. Regarding the CD occupancy of the pattern in FIG. 2(A), since the CD axis is parallel to the CD rows, the CD occupancy is the same as a proportion of a sum of widths (W₁-Wn) of thermal compression bonded portions disposed in one CD row to an overall CD width.

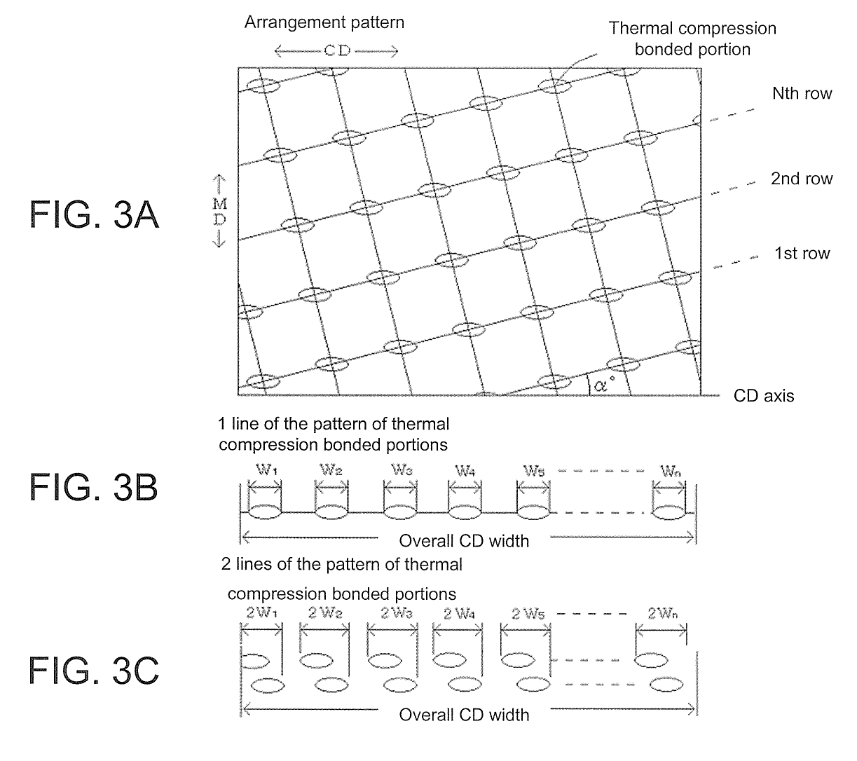

In FIG. 3(A), the pattern of the thermal compression bonded portions in FIG. 2 is rotated by α° in a counter-clockwise direction, such that the CD rows have an angle of α° relative to the actual CD. In this case, the CD occupancy of one row is as shown in FIG. 3(B), which is a proportion of a sum of W₁-Wn when widths of thermal compression bonded portions in one row are projected on the CD axis to the overall CD width.

However, since the pattern has an angle, the CD occupancy of two CD rows is shown in FIG. 3(C), which becomes a proportion of a sum of 2W₁-2Wn to the overall CD width. Actually, since the CD rows are gradually staggered regularly in the order of the 1st row, the 2nd row, the 3rd row, . . . , the CD occupancy when multiple CD rows are projected on the CD axis reaches 100%.

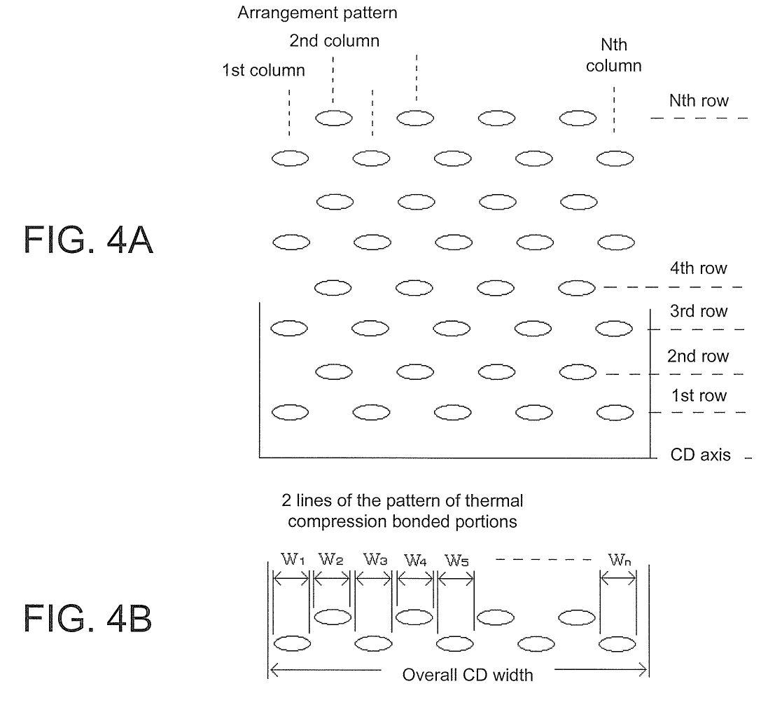

FIG. 4(A) shows an illustration of a pattern of thermal compression bonded portions in a staggered arrangement (a pattern formed by alternately arranging the thermal compression bonded portions in CD rows is referred to as the staggered arrangement). With equal distance between the CD rows and equal distance between the MD columns, the thermal compression bonded portions are respectively arranged repeatedly in a unit of two continuous rows and columns. Besides, the interval between the CD rows may be the same as or different from that between the MD columns. Regarding a CD occupancy of the pattern in FIG. 4(A), since the CD axis is parallel to the CD rows, as shown in FIG. 4(B), the CD occupancy is the same as a proportion of a sum of W₁-Wn when widths of the thermal compression bonded portions in two continuous CD rows are projected on the CD axis to the overall CD width.

Although not shown, the staggered arrangement may be similarly rotated by α° to the grid arrangement as shown in FIG. 3. In this case, CD rows are gradually staggered regularly in a unit of two continuous rows, and the CD occupancy when multiple CD rows are projected on the CD axis similarly reaches 100% as described above.

In the case that the interval between the CD rows is the same as that between the MD columns in FIGS. 3(A) and 4(A), a quadrangle formed by the CD rows and the MD columns is a square. Therefore, FIG. 3(A) becomes a pattern similar to FIG. 4(A) if being tilted by 45°; on the contrary, FIG. 4(A) becomes a pattern similar to FIG. 3(A) if being tilted by 45°.

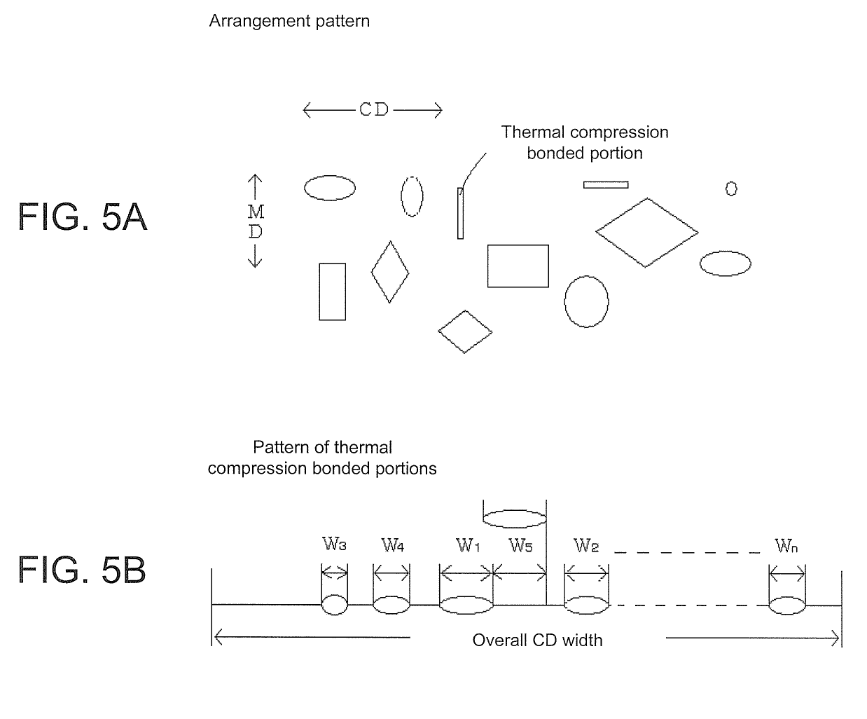

FIG. 5(A) shows an illustration of irregular shapes and arrangement of the thermal compression bonded portions. In this case, a CD occupancy is a proportion of a sum of widths of the thermal compression bonded portions projected on the CD axis one by one starting from a compression bonded portion close to the bottom edge of FIG. 5(A) which are set to W₁, W₂, W₃, . . . , Wn, and W₁-Wn to the overall CD width, as shown in FIG. 5(B).

In addition, even if the pattern in FIG. 5(A) is rotated by α°, the CD occupancy can be calculated similarly as described above since the original arrangement is irregular.

Further, an MD dry heat shrinkage rate of the raw nonwoven used in the present invention is preferably 3.5%-23%, and particularly preferably 4%-20%. The heat shrinkage of fibers is important in facilitating the formation of the fine folded structures, and particularly, a shrinkage rate of fibers of the residual (unmelted) high melting point component in the thermal compression bonded portions must be maintained in an appropriate range. In the case that the MD dry heat shrinkage rate is 3.5%-23%, folded structures can be easily formed, and distances between folded convex portions are sufficiently maintained to be less than or equal to 400 μm, so that the present invention can be implemented without considering the problem of generating partial tight warps or dense portions (lumps) on the finished nonwoven. Besides, the evenness of fiber dispersion in the nonwoven is kept good.

In order to obtain a nonwoven having the MD dry heat shrinkage rate described above, it is important to appropriately select spinning conditions such as the spinning speed and spinning temperature. The spinning conditions can be easily set by slightly suppressing a degree of crystallinity or molecular orientation at the high melting point component side. For example, for a nonwoven formed by a combination of PE/PET, the raw nonwoven having an MD dry heat shrinkage rate in the range of 3.5%-23% can be preferably obtained by setting the spinning speed in the range of 2000 m/min-3000 m/min and setting the spinning temperature in the range of 300° C.-350° C.

A width shrinkage of the nonwoven obtained by moderately extending the raw nonwoven is preferably as follows: a ratio of a CD width after the extension to a CD width before the extension is 0.1-0.7, and more preferably 0.2-0.6. In the case that the width shrinkage is 0.1-0.7, the low stress elongation defined in the present invention can be sufficiently maintained, and the present invention can be implemented without considering the problem of generating partial tight warps or dense portions (lumps) on the finished nonwoven as in the same case of the MD dry heat shrinkage rate. Besides, the evenness of fiber dispersion in the nonwoven is kept good.

In the present invention, conditions of thermal compression bonding for disposing the thermal compression bonded portions on the raw nonwoven are not specifically limited, as long as they are set to conditions in which a residual (unmelted) fiber structure of the high melting point component can be maintained in the thermal compression bonded portions. If the processing conditions are for the high melting point component in the thermal compression bonded portions to maintain a fiber shape, it is harmless even if the low melting point component is formed integrally throughout the thermal compression bonded portions by hot melting. In order to maintain the fiber structure of the high melting point component, it is particularly important to appropriately select a temperature, a line pressure, and other conditions in the thermal compression bonding. This method may utilize well-known conventional methods, a representative of which is a thermal compression bonding method of utilizing a hot embossing roll having convex portions on a surface thereof generally used in this technical field. Compression bonding conditions (temperature, line pressure, etc.) of the hot embossing roll for disposing the thermal compression bonded portions are different according to types of used resins. If the thermal compression bonding is implemented while a state of the themial compression bonded portions is observed, the conditions may be easily set in a common range.

For example, for thermal compression bonding conditions in the manufacturing of a spunbond raw nonwoven formed of a combination of PE/PET or PE/PP, it is ideal that a roll temperature is in the range of 115° C.-140° C. and a line pressure is in the range of 20 N/mm-70 N/mm in the case that, for example, an embossing roll/swimming roll thermal compression bonding machine manufactured by Eduard Küsters Maschinenfabrik GmbH & Co. KG is used.

Besides, conditions of extension are not specifically limited in the present invention. The so-called extension refers to extension of a raw nonwoven in one direction of MD, in which a roll extension device or pin tentering extension device may be selected. By comparing a nonwoven width after the extension with a width of the raw nonwoven before the extension, the width is shrunk to 0.1-0.7, and thus a device not generating resistance to the width shrinkage is ideal. In the case that the roll extension device is used, the width may be shrunk to a predetermined width by adjusting an interval between a carrying roll and a stretch roll; in the case that the pin tentering extension device is used, extension may be performed and the width may be shrunk to a predetermined width by adjusting a pin tentering portion.

Then, conditions of extension such as the temperature and extension ratio (drawing ratio) for exhibiting predetermined fine folded structures in the thermal compression bonded portions are illustrated as follows.

The heating in the case of roll extension may be common roll heating or any one of hot air drying, steaming, and hot water chamber heating between the carrying roll and the stretch roll or a combination of multiple heating modes. The heating in the case of pin tentering extension may be hot air drying, far infrared heating, or other modes.

The extension temperature is ideally a temperature at which the sheath side forming the raw nonwoven, i.e., the low melting point component, is not melted, the low melting point component and the high melting point component are plasticized, and appropriate heat shrinkage is exerted. For example, for a nonwoven formed of a combination of PE/PET, the extension temperature is preferably in the range of 50° C.-120° C. when both the plasticizing temperature and melting temperature of the low melting point component, i.e., PE, and the plasticizing temperature of the high melting point component, i.e., PET, are taken into consideration, and more preferably in the range of 80° C.-100° C. when extensibility is ensured and the feeling of the nonwoven as well as stabilization of physical properties such as low stress elongation is realized.

The extension ratio (drawing ratio) is ideally set to an appropriate extension ratio (drawing ratio) at which composite fibers of areas other than the thermal compression bonded portions are orientated in the MD and thus are not broken even if being stretched and the thermal compression bonded portions of the raw nonwoven are not destroyed. In order to obtain fine folded structures in the thermal compression bonded portions of the present invention, the higher the extension ratio (drawing ratio) is set without breaking or destroy, the larger the reaction stress applied in the CD will be, and the better effect will be achieved. For example, for the nonwoven formed of the combination of PE/PET, the extension ratio (drawing ratio) differs according to the compression bonding area rate, fiber diameter, weight per square meter, extension temperature, etc. of the raw nonwoven and may be selected to be in the range of 1.3-2.0 times.

The nonwoven of the present invention may be made into a laminate formed integrally with other layer materials such as fiber layers or films. In order to effectively utilize the property of low stress elongation in the present invention, the other layer material preferably has elastic performance, and may be a web, nonwoven, and film formed of fibers made of elastomer resin or a complex containing elastomer resin and substances having elastic performance in terms of structural features of the other layer material, for example, a web, dry nonwoven, spunlace nonwoven, mesh fabric, knitted fabric, etc. formed of crinkled fibers. Among them, spunbond nonwoven, meltblown nonwoven, and film using fibers made of elastomer resin or the complex containing elastomer resin as a raw material can easily achieve high elastic performance.

The elastomer resin may be polystyrene elastomer, polyolefine elastomer, polyester elastomer, polyamide elastomer, and polyurethane elastomer. Among them, the polystyrene elastomer, polyolefine elastomer, polyester elastomer, and polyamide elastomer are preferred in terms of recovery and reutilization.

The method of integrating laminated layers is not specifically limited, and may be the extrusion method, thermal compression bonding method, hot air penetration method, ultrasonic wave method, glue bonding method, hot melt resin fixation method, etc. In order to effectively exert the low stress elongation or elasticity of the present invention, a method causing as little damage as possible to the nonwoven in the present invention, especially the folded structures of the thermal compression bonded portions is preferred, and partial thermal compression bonding, ultrasonic wave bonding, and hot melt bonding are ideal. In addition, in the case of meltblown nonwoven, the meltblown nonwoven may be formed integrally with the nonwoven of the present invention by directly laminating meltblown fibers of elastomer resin in the production of the meltblown nonwoven.

Manufacturing equipment of the present invention includes a production line of the raw nonwoven and a nonwoven extension line, and sometimes further includes a lamination line. These lines may be separate lines, i.e., the so-called off-line, or form a line by connecting all the lines continuously, i.e., the so-called on-line. Besides, two lines may form an on-line, and the other is an off-line.

In addition, the nonwoven of the present invention is characterized in that, since the MD strength is almost not changed as compared with that of the raw nonwoven when the nonwoven is elongated by 5%, the nonwoven may be transported out along the MD in the processing of the laminate and the article without destroying the fine folded structures formed in the CD.

### EXAMPLES

The present invention is further illustrated below through examples and comparative examples.

In addition, measurement methods and evaluation methods in the examples and comparative examples are described as follows.

(1) Tensile Strength when the Nonwoven is Elongated by 5%

According to the tensile strength test method in JIS L 1906 “TEST METHODS FOR NON-WOVEN FABRICS MADE OF FILAMENT YARN,” an automatic plotter device (a tensile testing machine) is used to determine strengths of a test piece stretched by 5 mm relative to the length of a clamp of 100 mm for MD and CD.

(2) Tensile Strength when the Nonwoven is Elongated by 50%

The test piece is stretched by 50 mm, and the same method as that for the tensile strength when the nonwoven is elongated by 5% is used for measurement.

(3) Dry Heat Shrinkage Rate

According to the dry heat shrinkage rate test method in JIS L 1906 “TEST METHODS FOR NON-WOVEN FABRICS MADE OF FILAMENT YARN”, the MD shrinkage rate is calculated.

(4) Distance Between Adjacent Convex Portions of Fine Folded Structures of Thermal Compression Bonded Portions

The digital microscope VHX-900 manufactured by KEYENCE company is used to photograph 20 thermal compression bonded points randomly selected from the nonwoven by magnifying them by 200 times, and distances between adjacent convex portions of the 20 thermal compression bonded points are measured respectively to calculate an average of the distances.

### Example 1

A composite spunbond nonwoven having a CD width of 1100 mm and a weight per square meter of 25 g/m² is prepared. The composite spunbond nonwoven is formed by disposing high density PE having a melting point of 129° C., a density of 0.958 g/cm³, and a melt mass flow rate of 38 dg/min measured at 190° C. at the sheath side, disposing polyester having an intrinsic viscosity of 0.640 and a melting point of 254° C. at the core side, performing spinning under conditions in which a speed is 2700 m/min, a spinning temperature of the PE is 240° C., and a spinning temperature of the polyester is 320° C., and performing thermal compression bonding processing under conditions in which a line pressure is 45 N/mm and a temperature is 125° C. An overall area rate of the thermal compression bonded portions on the nonwoven is 21% of the nonwoven, the CD occupancy is 90%, and physical properties of the nonwoven are described as follows. The results are shown in Table 1.

Tensile strength when the nonwoven is elongated by 5%
MD: 22.9 N/5 cm
CD: 7.6 N/5 cm
MD/CD ratio: 3.0

Tensile strength when the nonwoven is elongated by 50%
MD: 70.6 N/5 cm
CD: 33.1 N/5 cm

MD dry heat shrinkage rate: 9.5%

The composite spunbond nonwoven is extended to 1.5 times in the MD direction by passing the composite spunbond nonwoven through a device having a dry hot air chamber disposed between heating rolls at a speed of about 20 m/min. At this time, the temperature of the rolls and the dry hot air is 80° C. The obtained nonwoven has a width of 281 mm and a weight per square meter of 54 g/m².

The obtained nonwoven is soft and has fine CD elongation property. Physical properties of the nonwoven are described as follows. The results are shown in Table 1.

Distance between adjacent convex portions of fine folded structures of thermal compression bonded portions
112 μm

Tensile strength when the nonwoven is elongated by 5%
MD: 99.8 N/5 cm
CD: 0.005 N/5 cm
MD/CD ratio: 19960

Tensile strength when the nonwoven is elongated by 50%
MD: broken
CD: 0.079 N/5 cm

CD width ratio
After extension/before extension: 0.26

As can be known from the results, the obtained nonwoven exhibits fine folded structures at thermal compression bonded portions, have strengths when being elongated by 5% and 50% in the CD direction greatly reduced as compared with those of the raw nonwoven, and can obtain low stress elongation.

### Example 2

Spinning is performed under conditions in which a speed is 2075 m/min and a spinning temperature of polyester is 305° C. In addition, a raw nonwoven is fabricated and extended similarly to Example 1 to obtain a nonwoven having a width of 384 mm and a weight per square meter of 29 g/m². The results are shown in Table 1.

### Example 3

A thermal compression bonding is performed at a line pressure of 25 N/mm. In addition, a raw nonwoven is fabricated and extended similarly to Example 1 to obtain a nonwoven having a width of 274 mm and a weight per square meter of 56 g/m². The results are shown in Table 1.

### Example 4

PE used in Example 1 is disposed at the sheath side, PP having a melting point of 162° C., a density of 0.961 g/cm³, and a melt mass flow rate of 42 dg/min measured at 230° C. is disposed at the core side, spinning is performed at a temperature of 240° C., and thermal compression bonding is performed under conditions in which a line pressure is 60 N/mm and a temperature is 135° C. In addition, a raw nonwoven is fabricated and extended similarly to Example 1 to obtain a nonwoven having a width of 318 mm and a weight per square meter of 38 g/m². The results are shown in Table 1.

### Example 5

An overall area rate of the thermal compression bonded portions is 10% of the nonwoven, and a CD occupancy is 54%. In addition, a raw nonwoven is fabricated and extended similarly to Example 1 to obtain a nonwoven having a width of 421 mm and a weight per square meter of 28 g/m². The results are shown in Table 1.

### Example 6

An overall area rate of the thermal compression bonded portions is 47% of the nonwoven, and a CD occupancy is 100%. In addition, a raw nonwoven is fabricated and extended similarly to Example 1 to obtain a nonwoven having a width of 205 mm and a weight per square meter of 32 g/m². The results are shown in Table 1.

### Comparative Example 1

Spinning is performed under conditions in which a speed is 3400 m/min and a spinning temperature of polyester is 305° C. In addition, a raw nonwoven is fabricated and extended similarly to Example 1 to obtain a nonwoven having a width of 850 mm and a weight per square meter of 29 g/m². The obtained nonwoven has a large after extension/before extension CD width ratio, and lacks elongation property. The results are shown in Table 1.

### Comparative Example 2

Spinning is performed under conditions in which a speed is 1720 m/min and a spinning temperature of polyester is 355° C. In addition, a raw nonwoven is fabricated and extended similarly to Example 1 to obtain a nonwoven having a width of 183 mm and a weight per square meter of 36 g/m². Although the obtained nonwoven exhibits the elongation property, fibers other than the thermal compression boned portions shrink more to generate partial tight warps, resulting in damage to the evenness of fiber dispersion in the nonwoven. The results are shown in Table 1.

### Comparative Example 3

Fibers formed of a single component of PP used in Example 4 are spun at a temperature of 240° C., and thermal compression bonding is performed under conditions in which a line pressure is 50 N/mm and a temperature is 142° C. In addition, a raw nonwoven is fabricated and extended similarly to Example 1 to obtain a nonwoven having a width of 365 mm and a weight per square meter of 23 g/m². The obtained nonwoven has a large after extension/before extension CD width ratio, and hardly exhibits the elongation property. The results are shown in Table 1.

### Comparative Example 4

An overall area rate of the thermal compression bonded portions is 74% of the nonwoven, and a CD occupancy is 100%. In addition, a raw nonwoven is fabricated and extended similarly to Example 1 to obtain a nonwoven having a width of 231 mm and a weight per square meter of 47 g/m². Although the nonwoven exhibits elasticity, the finished product of the nonwoven feels rough and hard as a whole and has a poor quality. The results are shown in Table 1.

### Comparative Example 5

An overall area rate of the thermal compression bonded portions is 5% of the nonwoven, and a CD occupancy is 28%. In addition to this, a raw nonwoven is fabricated and extended similarly to Example 1 to obtain a nonwoven having a width of 475 mm and a weight per square meter of 29 g/m². The obtained nonwoven has a large after extension/before extension CD width ratio, and lacks elongation property. The results are shown in Table 1.

### Comparative Example 6

A raw nonwoven the same as that used in Example 1 is extended to 1.5 times in the MD direction at 40° C. by passing the raw nonwoven through the same extension device. Although it is confirmed in the result that the nonwoven exhibits elongation property, the elongation property is not so large. The obtained nonwoven exhibits irregular folded structures in thermal compression bonded portions, partially has thermal compression bonded portions not exhibiting folded structures, has a large after extension/before extension CD width ratio, and lacks elongation property. The results are shown in Table 1.

TABLE 1

| | Raw Nonwoven | | | | | | | | | | | |
|---|---|---|---|---|---|---|---|---|---|---|---|---|
| | | | | | | | | | | MD dry | Weight | |
| | Raw Material | | Overall | | 5% Elongation | | | 50% Elongation | | Heat | per | |
| | for formation | | Area | CD | Strength | | | Strength | | Shrinkage | Square | CD |
| | Sheath | Core | Rate | Occupancy | N/5 cm | | MD/CD | N/5 cm | | Rate | Meter | Width |
| | Side | Side | % | % | MD | CD | Ratio | MD | CD | % | g/cm 2 | mm |
| Example 1 | PE | PET | 21 | 90 | 22.9 | 7.6 | 3.0 | 70.6 | 33.1 | 9.5 | 25 | 1100 |
| Example 2 | PE | PET | 21 | 90 | 11.1 | 3.8 | 2.9 | 38.0 | 16.2 | 4.5 | 17 | 735 |
| Example 3 | PE | PET | 21 | 90 | 22.9 | 7.6 | 3.0 | 70.6 | 33.1 | 9.5 | 25 | 1100 |
| Example 4 | PE | PP | 21 | 90 | 6.8 | 2.4 | 2.8 | 21.2 | 12.5 | 3.6 | 22 | 625 |
| Example 5 | PE | PET | 10 | 54 | 5.6 | 1.6 | 3.5 | 17.1 | 7.4 | 8.1 | 17 | 735 |
| Example 6 | PE | PET | 47 | 100 | 15.2 | 4.5 | 3.4 | 46.9 | 20.2 | 10.9 | 17 | 735 |
| Comparative | PE | PET | 21 | 90 | 25.3 | 9.1 | 2.8 | 79.2 | 39.9 | 2.6 | 25 | 1100 |
| Example 1 | | | | | | | | | | | | |
| Comparative | PE | PET | 21 | 90 | 19.5 | 6.0 | 3.3 | 58.8 | 26.3 | 25.0 | 17 | 735 |
| Example 2 | | | | | | | | | | | | |
| Comparative | PP | PP | 21 | 90 | 9.7 | 0.8 | 12.1 | 25.5 | 5.5 | 3.3 | 21 | 420 |
| Example 3 | | | | | | | | | | | | |
| Comparative | PE | PET | 74 | 100 | 28.6 | 12.4 | 2.3 | 80.0 | 37.3 | 15.4 | 25 | 625 |
| Example 4 | | | | | | | | | | | | |
| Comparative | PE | PET | 5 | 28 | 14.2 | 3.0 | 4.7 | 38.8 | 10.5 | 6.6 | 25 | 625 |
| Example 5 | | | | | | | | | | | | |
| Comparative | PE | PET | 21 | 90 | 22.9 | 7.6 | 3.0 | 70.6 | 33.1 | 9.5 | 25 | 1100 |
| Example 6 | | | | | | | | | | | | |

| | | Nonwoven After Extension | | | | | | | |
|---|---|---|---|---|---|---|---|---|---|
| | Distance | | | | | | Weight | | |
| | Between | 5% Elongation | | 50% Elongation | | | per | | |
| | Convex | Strength | | Strength | | | Square | CD | CD Width Ratio |
| | Portions | N/5 cm | | N/5 cm | | | Meter | Width | After Extension/ |
| | μm | MD | CD | MD/CD | MD | CD | g/cm 2 | mm | Before Extension |
| Example 1 | 112 | 99.8 | 0.005 | 19960 | Broken | 0.079 | 54 | 281 | 0.26 |
| Example 2 | 233 | 42.8 | 0.089 | 481 | Broken | 2.890 | 29 | 384 | 0.52 |
| Example 3 | 108 | 97.6 | 0.002 | 48800 | Broken | 0.006 | 56 | 274 | 0.25 |
| Example 4 | 243 | 19.1 | 0.084 | 227 | Broken | 4.330 | 38 | 318 | 0.51 |
| Example 5 | 122 | 13.5 | 0.002 | 6750 | Broken | 0.016 | 28 | 421 | 0.57 |
| Example 6 | 136 | 69.1 | 0.003 | 23033 | Broken | 0.133 | 32 | 205 | 0.28 |
| Comparative | 412 | 88.3 | 2.534 | 35 | Broken | 18.400 | 29 | 850 | 0.77 |
| Example 1 | | | | | | | | | |
| Comparative | 98 | 24.7 | 0.005 | 4940 | Broken | 0.091 | 36 | 183 | 0.25 |
| Example 2 | | | | | | | | | |
| Comparative | Unfolded | 14.2 | 0.550 | 26 | Broken | 3.160 | 23 | 365 | 0.87 |
| Example 3 | | | | | | | | | |
| Comparative | 161 | 121.9 | 0.388 | 314 | Broken | 0.102 | 47 | 231 | 0.37 |
| Example 4 | | | | | | | | | |
| Comparative | 143 | 17.0 | 0.111 | 153 | Broken | 3.201 | 29 | 475 | 0.76 |
| Example 5 | | | | | | | | | |
| Comparative | 464 | 43.0 | 2.242 | 19 | Broken | 14.260 | 28 | 885 | 0.80 |
| Example 6 | | | | | | | | | |

### INDUSTRIAL APPLICABILITY

Due to excellent elongation property and softness, the nonwoven of the present invention can be preferably used, for example, by laminating with a material having elasticity, for the following articles: elastic members for sanitary materials such as elastic members for disposable diapers, elastic members for diapers, elastic members for sanitary protection products, and elastic members for diaper covers, elastic belts, adhesive plasters, elastic members for clothes, lining fabrics for clothing materials, insulation materials or heat preservation materials for clothing materials, protective clothing, hats, masks, gloves, supporters, elastic bandages, backing fabrics for applying materials, backing fabrics for paste materials, antislip backing fabrics, vibration absorbing materials, fingerstalls, various filters such as air filters for clean rooms, blood filters, and oil-water separation filters, electret filters for electret processing, separators, heat barrier materials, coffee bags, food packing materials, various parts for automobiles such as ceiling skin materials for automobiles, sound proof materials, substrates, cushion materials, dustproof materials for loudspeakers, air purifier materials, insulator skins, backing materials, nonwoven bonded sheet materials, door trims, various cleaning materials such as cleaning materials of copy machines, coating materials and linings of carpets, agricultural roll-ups, wood drainage materials, materials for shoes such as athletic shoe skins, members for handbags, industrial sealing materials, wipping materials, bed sheets, etc.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A composite spunbond nonwoven, comprising:
a composite fiber comprising a low melting point component and a high melting point component,
wherein the composite fiber is partially thermal compression bonded to each other, thermal compression bonded portions are provided with fine folded structures formed by repeating convex portions and concave portions in a cross direction CD in nonwoven manufacturing, an average of distances between adjacent convex portions of the folded structures is in a range of 100 μm-400 μm, the composite spunbond nonwoven exhibits an elongation property by unfolding the fine folded structures, and when the composite spunbond nonwoven is elongated by 5%, a CD strength is less than or equal to 0.1 N/5 cm width, a MD/CD strength ratio is greater than or equal to 200, and MD is longitudinal direction in nonwoven manufacturing.

2. The composite spunbond nonwoven according to claim 1, wherein the CD strength is less than or equal to 5 N/5 cm width when the composite spunbond nonwoven is elongated by 50%.

3. The composite spunbond nonwoven according to claim 1, wherein a raw nonwoven before the folded structures are formed satisfies the following provisions of (A)-(C):
(A) an overall area rate of the thermal compression bonded portions is 7%-60% of the nonwoven;
(B) an occupancy of the thermal compression bonded portions continuously dotted in the MD relative to an overall CD width is greater than or equal to 50%; and
(C) an MD dry heat shrinkage rate is 3.5%-23%.

4. The composite spunbond nonwoven according to claim 2, wherein a raw nonwoven before the folded structures are formed satisfies the following provisions of (A)-(C):
(A) an overall area rate of the thermal compression bonded portions is 7%-60% of the nonwoven;
(B) an occupancy of the thermal compression bonded portions continuously dotted in the MD relative to an overall CD width is greater than or equal to 50%; and
(C) an MD dry heat shrinkage rate is 3.5%-23%.

5. The composite spunbond nonwoven according to claim 1, wherein a raw nonwoven before the folded structures are formed satisfies the following necessary conditions in (A)-(C):
(A) an overall area rate of the thermal compression bonded portions is 7%-60% of the nonwoven;
(B) an occupancy of the thermal compression bonded portions continuously dotted in the MD relative to an overall CD width is greater than or equal to 50%; and
(C) an MD dry heat shrinkage rate is 3.5%-23%,
and the raw nonwoven is uniaxially extended in the MD.

6. The composite spunbond nonwoven according to claim 2, wherein a raw nonwoven before the folded structures are formed satisfies the following necessary conditions in (A)-(C):
(A) an overall area rate of the thermal compression bonded portions is 7%-60% of the nonwoven;
(B) an occupancy of the thermal compression bonded portions continuously dotted in the MD relative to an overall CD width is greater than or equal to 50%; and
(C) an MD dry heat shrinkage rate is 3.5%-23%,
the raw nonwoven is uniaxially extended in the MD.

7. The composite spunbond nonwoven according to claim 5, wherein a ratio of a CD width after the extension to a CD width before the extension is 0.1-0.7.

8. The composite spunbond nonwoven according to claim 6, wherein a ratio of a CD width after the extension to a CD width before the extension is 0.1-0.7.

9. A laminate, formed by integrally forming other fiber layers or films with the composite spunbond nonwoven according to claim 1.

10. An article, obtained by using the composite spunbond nonwoven according to claim 1.

11. An article, obtained by using the laminate according to claim 9.
